(19) United States
(12) Patent Application Publication
(10) Pub. No.: US 2007/0030281 A1
(43) Pub. Date: Feb. 8, 2007

(54) Serial memory script controller

(75) Inventor: Chia-Hsin Chen, Taipei (TW)

Correspondence Address: John Chen, Room 303, 3F., No 25, Sec.1, Changan E. Road, Taipei, 10441, TW

(73) Assignee: Beyond Innovation Technology Co., Ltd.

(21) Appl. No.: 11/431,543

(22) Filed: May 11, 2006

Related U.S. Application Data
(60) Provisional application No. 60/702,119, filed on Jul. 25, 2005.

(51) Int. Cl. G09G 5/39

(52) U.S. Cl. 345/531

(57) ABSTRACT

The present invention provides an IC chip of a serial memory script controller, comprising: an interface transforming unit, an I/O buffer and data path control unit, a script decoder, an ALU and an event control unit. The interface transforming unit codes and decodes a communication protocol of a serial interface; the I/O buffer and data path control unit is electrically connected to the interface transforming unit, stores the input and output data of the interface transforming unit; and selects and controls the data path; the script decoder is electrically connected to the input/output buffer and data path control unit, and decode a program code stored in the input/output buffer and data path control unit, and then a corresponding control signal is transformed; the ALU is electrically connected to the input/output buffer and data path control unit and the script decoder, and executes an instruction operation in accordance with data of the input/output buffer and data path control unit and the script decoder; and the event control unit is electrically connected to the interface transforming unit, the input/output buffer and data path control unit, and the script decoder, and receives an event, wherein the interface transforming unit, the input/output buffer and data path control unit, and the script decoder execute processing and operation in accordance with the event. The serial memory script controller built in an IC chip to simplify the architecture inside the IC to achieve the advantages of the minification, thinning, increasing the performance, and decreasing the power consumption.

### BACKGROUND OF THE PRESENT INVENTION

1. Field of Invention

The invention relates to a serial memory script controller, and more particularly to a built-in serial memory script controller integrated in an IC chip.

2. Description of Related Arts

Because of the progress of the manufacturing process, there are more and more function units capable of being designed in a unit area. Therefore, there are many registers in an IC chip to provide the customized settings for the users' personal requirements. For example, in the signal processing chip, because everyone has a different visual feeling to an image, there are many built-in functions in an ordinary graphics processing chip, such as the contrast, light, sharpness and so on. And a customer can adjust the functions through a user interface. The LCD, CRT or plasma TV usually employs the micro control unit (MCU) cooperating with some key pads to have a customized adjustment in accordance with the user's personal required effect through the On Screen Display (OSD).

Taking the LCD as an example, the conventional architecture, as shown in FIG. 1, comprises a video source 101, a graphics processor (with a built-in OSD processing unit) 102, a display apparatus (a panel) 103, an MCU 104, a memory device (Serial EEPROM) 105, and a key pad 106 to fine-tune the effects of the graphics processor for a user.

The system provider codes the program dedicated to the MCU 104, sets the internal parameters of the graphics processor through a control interface 107 of the graphics processor (with a built-in OSD processing unit) 102, and processes the corresponding function settings displaying on the display apparatus (panel) 103 through the built-in OSD processing unit of the graphics processor 102 when the external key pad 106 is pressed. A user makes the settings through the information displayed on the OSD to achieve the required image effects. After the setting process has being finished, the MCU 104 stores the user's last settings in the memory device (Serial EEPROM) 105 to restore the user's settings of the image effects when turning on next time without need to set again.

Because of the progress of the IC manufacturing process, there are more circuits residing in the unit area of a wafer. As shown in FIG. 2, some of the providers of the graphics processor 202 build the MCU 204 in the graphics processor. But because of the diverseness of the manufacturing processes of the memories, there is a need to have a memory device (Serial EEPROM or Serial Flash) as the storage for the customized data, besides placing a program memory unit (Flash Memory) 207 out of the graphics processor 202.

To sum up the architectures of the system design of the two graphics processors in accordance with FIGS. 1 and 2, there are some common points:
1. they both need an external memory device (Serial EEPROM or Serial Flash) as the storage for the customized data;
2. they both employ the MCUs 104 and 204 as the control units, no matter of employing the built-in or external MCUs.

For the portable products, the trend of their development is toward minification and thinning more and more, and also less power consumption to have a longer working time. For the conventional architectures shown in FIGS. 1 and 2, there are some drawbacks when they are employed in the conventional products: (1) because there are some extra external devices, the area of the circuit board cannot be shrunk effectively, and it becomes the bottleneck for minificating products; (2) it consumes more power comparatively because the micro processor proceeds to fetch, decode and execute through the program RAM in accordance with the provided unstopped clock for the architecture employing the micro processor.

### SUMMARY OF THE PRESENT INVENTION

An object of the present invention is to provide a serial memory script controller built in an IC chip to simplify the architecture inside the IC to achieve the advantages of the minification and thinning.

Another object of the present invention is to provide a serial memory script controller built in an IC chip to improve the system performance and decrease the power consumption.

Accordingly, in script to accomplish the one or some or all above objects, the present invention is to provide a serial memory script controller comprising:

an interface transforming unit, coding and decoding a communication protocol of a serial interface;

an I/O buffer and data path control unit, electrically connected to the interface transforming unit, proceeding to store the input and output data of the interface transforming unit, and selecting and controlling the data path;

an script decoder, electrically connected to I/O buffer and data path control unit, interpreting a script code stored in the I/O buffer and data path control unit;

an ALU, electrically connected to the I/O buffer and data path control unit and the script decoder, executing an instruction operation in accordance with the data of the I/O buffer and data path control unit and the script decoder; and

an event control unit, electrically connected to the interface transforming unit, I/O buffer and data path control unit, and script decoder, receiving an event, wherein the interface transforming unit, I/O buffer and data path control unit, and script decoder proceed to process and operate in accordance the event.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 is a system circuit architecture of a conventional graphics processor.

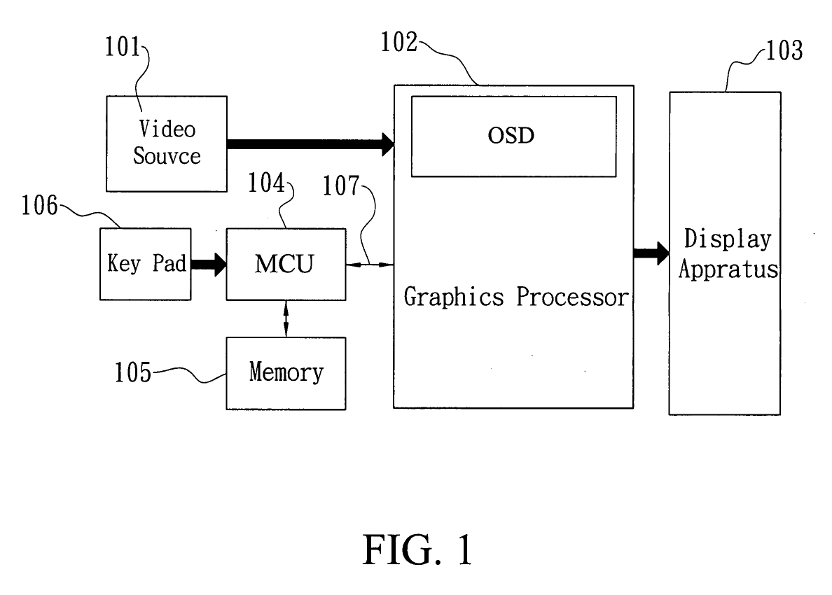

FIG. 2 is a system circuit architecture of a another conventional graphics processor.

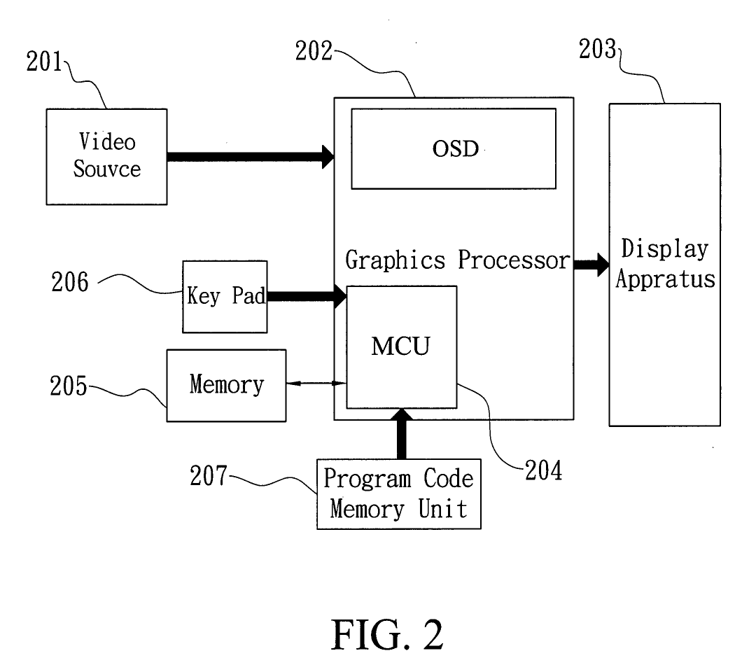

FIG. 3 is a system circuit architecture of a graphics processor in accordance with a preferred embodiment of the present invention.

FIG. 4 is a system circuit architecture of a serial memory script controller in accordance with a preferred embodiment of the present invention.

FIG. 5 is the diagram of the event address of the memory device and the execution flow path of the script code block in accordance with the embodiment of the present invention.

### DETAILED DESCRIPTION OF THE PREFERRED EMBODIMENT

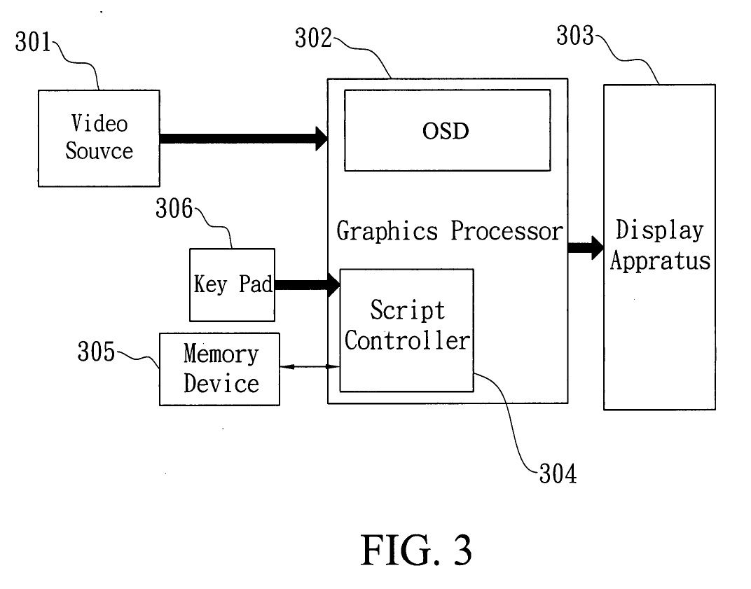

Referring to FIG. 3, it is the diagram of the system circuit architecture of the graphics processor in accordance with the preferred embodiment of the present invention. As shown in FIG. 3, an image is input to a graphics input source 301 through a graphics processor 302 of a built-in script controller 304 and sent to a display apparatus 303 after processed. And the script controller 304 is driven by an external key pad 306 to execute a program code stored in a memory device 305. The user's required parameters are set and, finally, the parameters set by the user are stored in the memory device 305 through the script controller 304 for the next-time usage.

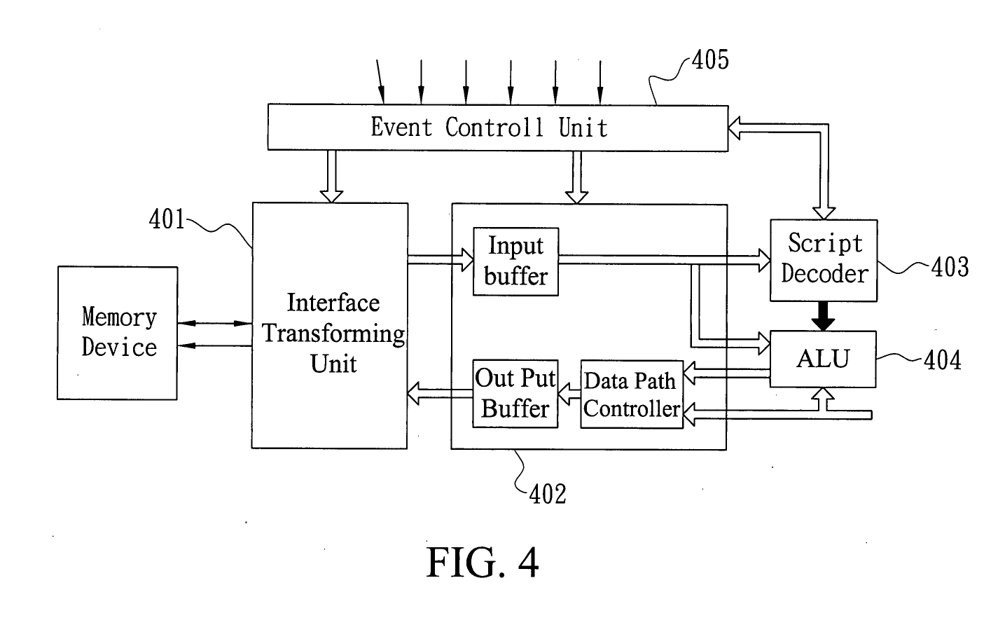

Referring to FIG.4, it is the diagram of the system circuit architecture of the serial memory script controller in accordance with the preferred embodiment of the present invention. As shown in FIG. 4, the serial memory script controller 304 comprises 5 parts in architecture:
1. an interface transforming unit (serial to parallel and parallel to serial) 401, coding and decoding the communication protocol of the serial interface, and transforming a serial data into a parallel data for the internal use of the serial memory script controller 304, or transforming the internal parallel data into serial data to output to a external device;
2. an input/output buffer and data path control unit 402, storing the input/output data of the interface transforming unit 401, and selecting and controlling the data path (ALU or internal register data);
3. a script decoder 403, decoding a script code stored in the memory device 305 of the serial interface and transforming the decoded script code into the corresponding control signals;
4. an ALU 404, executing the instructions of the logic or arithmetic operation; and
5. an event control unit 405, receiving an issued event from the graphics processor 302 and having a corresponding process.

The script code is classified into 5 categories: logic instructions, operation instructions, data movement instructions, script control, and system instructions. The classification is as following:
1. the operation instructions include the instructions related to the arithmetic operation, such as addition (ADD), subtraction (SUB), increasing (INC), decreasing (DEC), and so on;
2. the logic instructions include the instructions related to the logic process, such as AND, OR, XOR, NOT, and so on;
3. the data movement instructions include:
   (i) from a memory device (serial EEPROM) to an internal register (processor);
   (ii) from a memory device (serial EEPROM) to an operation register;
   (iii) from an internal register (processor) to a serial memory;
   (iv) from an internal register (processor) to an operation register;
   (v) from an operation register to an internal register (processor); and
   (vi) from an operation register to a serial memory.
4. the script instructions include the instructions related to the script control, such as unconditioned transfer instruction (JMP), transfer instruction when carrying (JC), transfer instruction without carrying (JZ), and so on;
5. the system instructions include the instructions related to the system control, such as delay, halt, and son on.

The event process is classified into 3 categories: external events, internal events, and special events. The classification is as the following:
1. the external events include:
   (i) general purpose input event (GPI), including the edge trigger and level trigger, provided to work as a key pad input or mode setting selection; and
   (ii) infrared remote control event, provided to work as a remote control.
2. the internal events include:
   (i) mode change event, adapted when the input mode is changed, such as the switching of the frequencies input format (NTSC/PAL) and the graphics displaying array (VGA to SVGA);
   (ii) no signal detect event, adapted when input signal is lost, such as when a signal is stopped, or a signal line is unplugged; and
   (iii) VSYNC detect event, adapted when the frequencies (VSYNC) change and working as a counter.
3. the special events include:
   (i) power on event, the first position of the program when activating the power;
   (ii) power off event, adapted when shutting down the power; and
   (iii) internal event, adapted when detecting the internal mistake.

The operation mode is classified into 2 categories:
1. execution mode: under the mode, the script code is retrieved from the memory device (serial EEPROM or serial flash) and decoded to execute, and the control unit is operated at full speed to consume the largest power; and
2. monitoring mode: under the mode, the set event is detected whether is activated, and only the control unit for the event is operated to consume the smallest power.

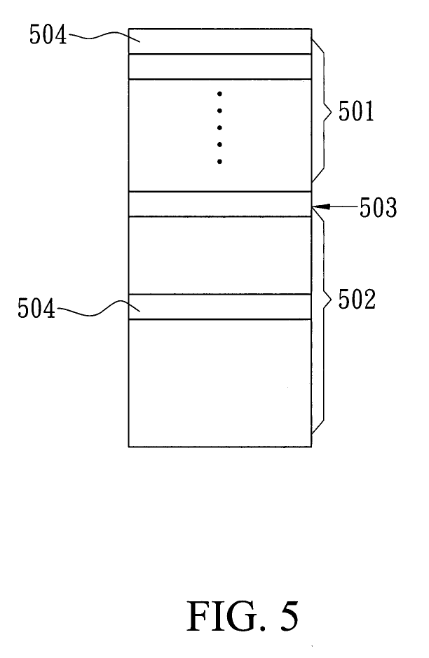

Referring to FIG. 5, it is the diagram of the event address of the memory device and the execution flow path of the script code block in accordance with the embodiment of the present invention. As shown in FIG. 5, the execution flow path is as the following: an event address 501 and a script code 502 are configured as 2 blocks in the memory device (serial EEPROM or serial flash); when power-on, the first script code is retrieved from the power on reactivation (POR) address as the program position, and executed until the Halt instruction is received to stop the execution and the event monitor is adapted; when an event happens, the corresponding event program code 504 is retrieved from the event control unit and the execution mode is adapted to execute the corresponding program code of the event address until the halt instruction (HAL) is received to stop the execution and the event monitor is adapted.

One skilled in the art will understand that the embodiment of the present invention as shown in the drawings and described above is exemplary only and not intended to be limiting.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in script to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A serial memory script controller, comprising:
an interface transforming unit, coding and decoding a communication protocol of a serial interface;
an input/output buffer and data path control unit, electrically connected to the interface transforming unit, and storing the input and output data of the interface transforming unit and selecting and controlling a data path;
a script decoder, electrically connected to the input/output buffer and data path control unit, and decoding a program code stored in the input/output buffer and data path control unit, and then coresponsively generating a control signal;
an arithmetic logic unit (ALU), electrically connected to the input/output buffer and data path control unit and the script decoder, executing an instruction operation in accordance with data of the input/output buffer and data path control unit and the script decoder; and
an event control unit, electrically connected to the interface transforming unit, the input/output buffer and data path control unit, and the script decoder, receiving an event, wherein the interface transforming unit, the input/output buffer and data path control unit, and the script decoder execute processing and operation in accordance with the event.

2. The serial memory script controller according to the claim 1, wherein the instruction operation is selected from a logic instruction and an arithmetic operation instruction.

3. The serial memory script controller according to the claim 1, wherein the script code is selected from a logic instruction, an operation instruction, a data movement instruction, a script control, and a system instruction.

4. The serial memory script controller according to the claim 2, wherein the program code is selected from a logic instruction, an operation instruction, a data movement instruction, a script control and a system instruction.

5. The serial memory script controller according to the claim 1, wherein the event is selected from an external event, an internal event, and a special event.

6. The serial memory script controller according to the claim 2, wherein the event is selected from an external event, an internal event, and a special event.

7. The serial memory script controller according to the claim 3, wherein the event is selected from an external event, an internal event, and a special event.

8. The serial memory script controller according to the claim 4, wherein the event is selected from an external event, an internal event, and a special event.

9. A serial memory script controller, comprising:
an interface transforming unit, coding and decoding a communication protocol of serial interface, transforming a serial data into a parallel data to provide for internal use of the serial memory script controller, and transforming the internal parallel data into the serial data to output;
an input/output buffer and data path control unit, electrically connected to the interface transforming unit, storing the input and output data of the interface transforming unit, and selecting and controlling a data path;
a script decoder, electrically connected to the input/output buffer and data path control unit, and decoding a program code stored in the input/output buffer and data path control unit, and then coresponsively generating a control signal;
an arithmetic logic unit (ALU), electrically connected to the input/output buffer and data path control unit and the script decoder, executing an instruction operation in accordance with data of the input/output buffer and data path control unit and the script decoder; and
an event control unit, electrically connected to the interface transforming unit, the input/output buffer and data path control unit, and the script decoder, receiving an event, wherein the interface transforming unit, the input/output buffer and data path control unit, and the script decoder execute processing and operation in accordance with the event.

10. The serial memory script controller according to the claim 9, wherein the instruction operation is selected from a logic instruction and a arithmetic operation instruction.

11. The serial memory script controller according to the claim 9, wherein the script code is selected from a logic instruction, an operation instruction, a data movement instruction, a script control, and a system instruction.

12. The serial memory script controller according to the claim 9, wherein the event is selected from an external event, an internal event, and a special event.

13. A system circuit architecture of a graphics processor, comprising:
an image input source, providing an image;
a memory device, storing a program code;
a displaying apparatus; and
a graphics processor, electrically connected to the image input source, the memory device, and the displaying apparatus wherein the graphics processor comprises a built-in script controller to process the image and then transmit a processed result to the displaying apparatus, and the built-in script controller is electrically connected to the memory device and retrieves the program code to execute image processing.

14. The system circuit architecture of a graphics processor according to the claim 13, further comprising a key pad electrically connected to the script controller, driving the script controller to execute the program code stored in the memory device to set a required parameter of a user.

15. The system circuit architecture of a graphics processor according to the claim 13, wherein the script controller comprises:
an interface transforming unit, coding and decoding a communication protocol of serial interface;
an input/output buffer and data path control unit, electrically connected to the interface transforming unit, storing the input and output data of the interface transforming unit, and selecting and controlling a data path;
a script decoder, electrically connected to the input/output buffer and data path control unit, and decoding a program code stored in the input/output buffer and data path control unit, and then coresponsively generating a control signal;
an arithmetic logic unit (ALU), electrically connected to the input/output buffer and data path control unit and the script decoder, executing an instruction operation in accordance with data of the input/output buffer and data path control unit and the script decoder; and
an event control unit, electrically connected to the interface transforming unit, the input/output buffer and data path control unit, and the script decoder, receiving an event, wherein the interface transforming unit, the input/output buffer and data path control unit, and the script decoder execute processing and operation in accordance with the event.

16. The system circuit architecture of a graphics processor according to the claim 14, wherein the script controller comprises:
an interface transforming unit, coding and decoding a communication protocol of serial interface;
an input/output buffer and data path control unit, electrically connected to the interface transforming unit, storing the input and output data of the interface transforming unit, and selecting and controlling a data path;
a script decoder, electrically connected to the input/output buffer and data path control unit, and decode a program code stored in the input/output buffer and data path control unit, and then coresponsively generating a control signal;
an arithmetic logic unit (ALU), electrically connected to the input/output buffer and data path control unit and the script decoder, executing an instruction operation in accordance with data of the input/output buffer and data path control unit and the script decoder; and
an event control unit, electrically connected to the interface transforming unit, the input/output buffer and data path control unit, and the script decoder, receiving an event, wherein the interface transforming unit, the input/output buffer and data path control unit, and the script decoder execute processing and operation in accordance with the event.

17. The system circuit architecture of a graphics processor according to the claim. 15, wherein the instruction operation is selected from a logic instruction and an arithmetic operation instruction.

18. The system circuit architecture of a graphics processor according to the claim 16, wherein the instruction operation is selected from a logic instruction and an arithmetic operation instruction.

19. The system circuit architecture of a graphics processor according to the claim 15, wherein the script code is selected from a logic instruction, an operation instruction, a data movement instruction, a script control, and a system instruction.

20. The system circuit architecture of a graphics processor according to the claim 16, wherein the script code is selected from a logic instruction, an operation instruction, a data movement instruction, a script control, and a system instruction.

21. The system circuit architecture of a graphics processor according to the claim 15, wherein the event is selected from an external event, an internal event, and a special event.

22. The system circuit architecture of a graphics processor according to the claim 16, wherein the event is selected from an external event, an internal event, and a special event.
